(19) United States
(12) Patent Application Publication
(10) Pub. No.: US 2024/0202763 A1
(43) Pub. Date: Jun. 20, 2024

(54) BLOCKCHAIN-BASED REWARD SYSTEM

(71) Applicant: Touch Point Worldwide, Inc., Costa Mesa, CA (US)

(72) Inventors: Daniel Kang, Costa Mesa, CA (US); Thomas Chen, Costa Mesa, CA (US); Jonathan Ko, Costa Mesa, CA (US)

(21) Appl. No.: 18/593,592

(22) Filed: Mar. 1, 2024

Related U.S. Application Data
(63) Continuation of application No. 17/840,259, filed on Jun. 14, 2022.

(51) Int. Cl. G06Q 30/0214; G06Q 50/00

(52) U.S. Cl. CPC G06Q 30/0214; G06Q 50/01

(57) ABSTRACT

Methods and systems are presented for providing rewards and enhanced user experience via blockchain technologies. A reward system uses blockchain technologies to evaluate one or more attributes of a wireless connection between two user devices. A first user can scan a code associated with an instance of a product, where the instance of the product is associated with a second user. A wireless connection can then be established between the two devices, and content stored on the device of the second user and associated with the instance of the product can be transmitted to the device of the first user. Certain attributes of the wireless connection and the content shared can determine what type of reward the second user is given.

### CROSS REFERENCE TO RELATED APPLICATION

This is a Continuation of U.S. patent application Ser. No. 17/840,259, filed Jun. 14, 2022, which is incorporated herein by reference in its entirety.

### TECHNICAL FIELD

The present specification generally relates to providing a reward system associated with a physical product based on blockchain.

### BACKGROUND

A referral program is a marketing tactic that encourages existing customers to share a certain brand or product with their friends, colleagues, and family members. In exchange for their effort, a referral program typically offers customers a reward, such as a gift card, a discount, points, or swag. Referral programs are successful because consumers generally trust their peers more than any group or advertisements. Currently, there is no reward program associated with referring people based on blockchain. Thus, there is a need to provide a platform for providing rewards to consumers that refer other people to purchase or otherwise consider a product.

### BRIEF DESCRIPTION OF THE FIGURES

FIG. 1 is a block diagram illustrating a networked system that includes a product connectivity module according to an embodiment of the present disclosure;

FIG. 2 is a schematic view illustrating an electronic token according to an embodiment of the present disclosure;

FIG. 3 is a schematic view illustrating a token transaction ledger according to an embodiment of the present disclosure;

FIG. 4 is a flowchart showing a reward process according to an embodiment of the present disclosure; and

FIG. 5 is a block diagram of a system for implementing a device according to an embodiment of the present disclosure.

### DETAILED DESCRIPTION

The present disclosure includes methods and systems for providing a reward system and enhanced user experience with the product via blockchain technologies. In some embodiments, a first user takes an interest in an instance of a product associated with (e.g., owned by) a second user and interact with the instance of the product using a device of the first user. The interaction with the instance of the product may trigger actions that affect the first user and/or the second user. In some embodiments, the interaction with the instance of the product may include the first user using an application of a device to scan a code that appears on and/or affixed to the instance of the product. Based on the interactions (and attributes associated with the interactions), rewards may be provided to the second user, content regarding the product may be provided to the first user, and incentives for purchasing the product may be provided to the first user.

In various embodiments, the content is stored on a device of the second user, and is transmitted from the device of the second user to the device of the first user via a wireless connection (e.g., a peer-to-peer wireless connection such as a Bluetooth® connection, etc.). In some embodiments, the second user may also generate content associated with the instance of the product (e.g., review of the product, etc.) that is stored and hosted by a third-party server (e.g., a product review website). Based on the interaction between the device of the first user and the instance of the product, the reward system may automatically retrieve the content from the third-party server and transmitted to the device of the first user.

Advantageously, a first user account associated with the first user can be connected with a second user account associated with the second user in a decentralized social network associated with the product so that content associated with the product can be shared directly between the first user and the second user, without requiring a third party server to facilitating the sharing of content. The decentralized social network connects users based on interactions with and association with the same product, such that content associated with the same product can be shared among the different users who are connected within the network via peer-to-peer connections without going through a third-party server. In several embodiments, content associated with the product and stored in a third device is shared among the first user device and the second user device based on the connection between the first user and the second user within the decentralized central network. For instance, even though the first user may not have interacted with a third user, if the third user is connected to the first user (e.g., via the second user) within the decentralized social network, the reward system may facilitate the sharing of content associated with the product between the first user and the third user. When the device of the first user is detected to be within a threshold distance with a device of the third user, the reward system may establish a wireless connection between the two devices and facilitate the peer-to-peer sharing of content associated with the product.

In certain embodiments, once an interaction is detected between the first user device (i.e., the device of the first user) and the instance of the product associated with the second user (e.g., a code associated with the instance of the product being scanned or otherwise captured by the first user device using a camera, an RFID scanner, a near-field connection (NFC) module, etc.), a wireless connection is established between the first user device and the second user device (i.e., the device of the second user). The code may appear on and/or affixed to the instance of the product, for example. Certain attributes of the wireless connection are determined to evaluate the reward for the second user. For example, a duration of the wireless connection and/or a detected distance between the first user device and the second user device can determine what kind of reward to provide to the second user. In some instances, the longer the duration of the wireless connection and the smaller the detected distance between the two devices, the greater the reward given to the second user. In some embodiments, a distance between the first device and the second device (or the instance of the product) can be measured during the interaction. A shorter distance between the first device and the second device (or the instance of the product) indicates a more intimate interaction between the first user and the instance of the product (e.g., the second user allowing the first user to physically handle/manipulate/try on the instance of the product). Thus, a shorter distance may lead to a higher reward provided to the second user. In some embodiments, a frequency of the interaction may also be monitored by the reward system such that a higher frequency of interactions between the first user and the instance of the product (e.g., a higher frequency of scanning of the code by the device of the first user) may lead to a higher reward for the second user. Content generated by the second user can also be evaluated to determine the reward for the second user. For example, the more content and the greater the quality of the content generated by the second user and shared with the first device, the better the reward given to the second user.

In some embodiments, in addition to providing rewards to the second user, an incentive may also be provided to the first user for purchasing the product. The incentive may also be calculated based on the attributes of the interactions using the same techniques as discussed herein, such that a higher incentive may be offered to the first user when the duration of the interaction is longer.

A token associated with the instance of the product may be initially stored in (and associated with) a digital wallet of the second user (e.g., the owner of the instance of the product). In some embodiments, a unique token is generated for each instance of the product. The token may also be referred to as a non-fungible token as each token is associated with a unique instance of a physical product. Furthermore, the content that is added to the blockchain in association with each token can be unique as well, as will be explained in more detail below. In addition, the reward and/or the incentive for the first user and the second user may also be stored on the blockchain (or in a data structure in association with the blockchain), such that third-party entities, such as the manufacturer of the product, a retailer of the product, etc. may provide the reward and/or the incentive to the appropriate parties by accessing the blockchain.

The transfer of the token to the wallet associated with the second user when the second user purchases the instance of the product causes a new transaction block to be recorded in a product blockchain structure (also referred to as a “blockchain” or a “ledger”). The new transaction block indicates a transfer of the corresponding token from the manufacturer or retailer to the second user. The second user may add content for the instance of the product. For example, via a user interface provided by a service provider, the second user may generate and add the content in association with the token. The content may be stored in a new transaction block that is recorded in the product blockchain structure, stored in the transaction block that indicates the transfer of the corresponding token from the manufacturer to the second user, or stored in a separate data structure (e.g., a record in a separate database) that is associated with the token. The content may include information associated with the use of the product, such as pictures, videos, and reviews of the product.

In one or more embodiments, other entities, such as a manufacturer of the product, can also add content for the instance of the product. The content added by the manufacturer may include information associated with the product (e.g., a serial number of the product, dimensions, colors, visual characteristics, edge-based attributes for object recognition, instruction manual, etc.), information associated with the manufacturer (e.g., a mission statement, etc.), advertisement content (e.g., text and/or multi-media content related to recommended products, etc.) and other information. It has been contemplated that the content generated and stored in association with the token by the manufacturer and/or other entities of the product may include text data, multi-media data (e.g., audio data, video data, etc.) and augmented reality data. Thus, the content can be incorporated within an image or video of the corresponding instance of the product. Since each instance of the product may be made from different materials (e.g., materials from a different source or origin, etc.) or made using a different process, the individualized tokens and their associated transaction blocks (or metadata) may include information that is specific to that instance of the product.

In some embodiments, one or more codes associated with the instance of the product may be affixed to the instance of the product (e.g., an RFID tag, an NFC chip, a bar code, a QR code, etc.). A user may then scan the one or more codes using an RFID reader, an NFC reader, an image scanner, etc.) The scanning of the code constitutes an interaction with the instance of the product, may cause a wireless connection to be established between the first user device and the second user device so that content can be transmitted from the second user device to the first user device directly via the wireless connection.

The code may be visually presented, such as a bar code, a QR code, etc. that can be shown or attached to the instances of the product. In a non-limiting example, the unique code may be generated based on hashing a token identifier of the token corresponding to the instance of the product. The unique code may be placed on the instance of the product (e.g., printed, engraved, embedded within an RFID tag, embedded within an NFC chip, etc.) or attached to the instance of the product (e.g., tied in a tag, etc.). A consumer of the product or others may use the service provider server system to access enhanced services (e.g., enhanced user experiences, etc.) related to an instance of the product based on the code. For example, a user may use a user device to scan the code (e.g., obtaining an image of the bar code or QR code using a camera, reading the code using an RFID reader and/or an NFC reader, etc.). The user may submit the code to the reward system (e.g., via an application of the user device).

In some embodiments, the reward system may provide an application that can be installed in any user devices (e.g., personal computers, mobile devices, etc.). For example, a user who becomes an owner of an instance of the product (e.g., the user purchases the product) may use the application on a user device to scan the code of the instance of the product to access additional services. In another examples, users who are not owners of the instance of the product, but are in proximity (e.g., within a predetermined distance based on the technical capability of scanning the code, etc.) of the instance of the product, may also acquire certain additional services by scanning the code using the application of their devices. In some embodiments, the application is part of the reward system (e.g., a mobile application of the reward system).

Upon receiving the code, the reward system may establish a wireless connection between the first user device and the second user device. For example, the first user may use an application associated with the reward system and executed on the device of the first user to scan the code of the instance of the product. The application may transmit the code to a reward server of the reward system. The reward server may determine a token based on the code (e.g., using a hash table), and may identify an owner (e.g., the second user) of the instance of the product based on the token and records stored on the blockchain. If a token is determined based on the code, the reward system may traverse the product blockchain to access data associated with the token (e.g., the data stored in transaction blocks associated with the token). The data retrieved from the blockchain may include identities of entities that possessed the token in the past (e.g., the manufacturer, the previous owner(s), the current owner, etc.), the content generated and added by the manufacturer or owners of the product, and other information. Based on the information, the reward server may determine the second user as the current owner of the instance of the product. The reward server may then communicate with the application executed on the device of the second user, and request the application of the device of the second user to establish a peer-to-peer wireless communication connection with the application of the device of the first user, such that data (e.g., content related to the product) can be shared between the devices of the first and second users.

The reward system may also retrieve device attributes associated with the user device that submitted the code. The device attributes retrieved by the service provider may include a geographical location detected by a geographical component of the user device (e.g., a GPS component), a network address (e.g., an Internet Protocol (IP) address, a media access control (MAC) address, etc.) of the user device, an identifier of the user of the user device (e.g., an account identifier, a name, an international mobile equipment identifier (IMEI), etc.), and other attributes.

In some embodiments, when a first consumer purchases the instance of the product from a retailer, the corresponding token is also transferred to a wallet of the first consumer. The possession of the token enables the first consumer to access the information associated with the instance of the product, and also add additional user-generated content for the instance of the product. For example, multi-media data such as images or videos that the first consumer generates (e.g., photos/videos of the instance of the product, of any modification or enhancement to the instance of the product, etc.) can be added for the instance of the product, via a user interface provided by the service provider server.

Content may also include promotional data for promoting the product or other related products from the manufacturer (e.g., discount offers, advertisements, etc.). Thus, through the reward server, manufacturers can directly communicate with their consumers and others who may be interested in their products (e.g., the people who scan the codes associated with different instances of the product). The manufacturer may upload different promotional data to the blockchain at different times to provide new promotional content to the owners and other potential consumers of the product. In some embodiments, the service provider server may enable the manufacturer to provide targeted promotional data. For example, the reward server may allow the manufacturer to provide different versions of promotional materials (e.g., for different products, for different discounts, for different incentives, etc.), and configurations for when the different versions of the promotional materials can be presented to user devices. The configurations may be location-specific (e.g., show a particular promotional material when the requesting device is located within a certain geographical area, etc.), time-specific (e.g., show a particular promotional material when the request is made at a specific time, etc.), demographic-specific (e.g., show a particular promotional material when the requester is within a certain age-range, is a particular gender, has a certain income range, etc.) or dependent on any attribute of the requester and/or the requesting device. The configurations and the different versions of the promotional materials may be stored in the blockchain (or in a data storage linked to the blockchain) and may be retrieved by a user application of a user device as the user application scans a code corresponding to an instance of the product. Based on the configurations and attributes of the user device, the user application may select and present one or more of the promotional materials. For example, the user application may determine a location of the user device, a time of day when the code is scanned, attributes of a user of the user device (e.g., an age, a gender, an income, etc.), and/or other attributes, and may select the appropriate promotional materials based on the attributes. This way, the manufacturers can provide targeted advertisement to the public through the service provider.

In some embodiments, the service provider platform may provide access control to the content associated with the instance of the product. For example, based on an identity of the requester (e.g., an owner of the instance of the product, a person who is in proximity of the instance of the product and scans the code, etc.), the platform may provide the requester access to different portions of the content. In one example, the service provider platform may allow the owner of the instance of the product access to all content on the blockchain in association with the token but may only allow other users who scan the code to access only a portion of the content (e.g., excluding content generated by previous and current owners, excluding special content generated by the manufacturer, etc.).

In some embodiments, a token representing an instance of a product, or the combination of the token and the content stored on the blockchain in association with the token, are referred to as a non-fungible token (NFT), which are transferrable between different users separate from the instance of the product, or in connection with the instance of the product. For example, a first user who is the owner of the NFT (who is also the owner of the corresponding instance of the product) may decide to sell the instance of the product to a second user. In addition to transferring the physical copy of the product, the first user may transfer the token (the NFT) from a wallet of the first user to a wallet of the second user. In another example, the first user may transfer the NFT (e.g., the token and all the content stored on the blockchain in association with the token) to the second user without transferring the physical copy of the product (e.g., keeping the instance of the product). Thus, the token (the NFT) can be treated as a separate asset independent of the corresponding physical copy of the product. In some embodiments, the code that appears on or affixed to the instance of the product for scanning is generated by the reward system based on the token (e.g., hashing the token, etc.)

In some embodiments, the content that is added to the blockchain (or a data structure associated with the blockchain) in association with the token may include a digital version of the instance of the product (which can be generated by the manufacturer, the service provider platform, or other entities), which can be manipulated within a computer virtual environment. The digital version of the instance of the product may include a digital object having a set of attributes. The set of attributes may describe the characteristics of the instance of the product as presented in the virtual environment (e.g., a size, a color, a style, a shape, etc.). The digital object may include a three-dimensional view of the copy of the product such that the digital object can be rendered as a three-dimensional object within the virtual environment. The digital object may also include the code that is attached to the physical instance of the product. In some embodiments, the reward system may also facilitate the transport of the digital object into a virtual environment and between different virtual environments.

For example, the reward system may establish communications with different virtual environment platforms (e.g., virtual environment platforms that support different computer games that can be played within different virtual environments, etc.). The reward system may communicate with the different virtual environment platforms through a set of application programming interfaces (APIs) and may be configured to receive requests for importing digital objects associated with different real-world physical instances of products.

When a user submits a request to import a digital object associated with an instance of a product via a gaming console, the request may be forwarded to the reward system through the set of APIs. The reward system may request the user to submit proof of ownership of the corresponding token (e.g., by being authenticated as the owner of the digital wallet account that owns the token, such as encoding a message using a private key of the digital wallet account, etc.). In some embodiments, the user may use the user application to communicate credential data to the gaming console for completing the authentication process.

Once the user is authenticated and verified as the owner of the token, the reward system may transfer data associated with the digital object to the virtual environment platform. The virtual environment platform may render the digital object within the game that the user is playing. Based on the characteristics specified in the digital object, the user may manipulate the rendering of the digital object within the game (e.g., wearing the digital object, carrying the digital object, presenting the digital object to other users in the virtual environment, using the digital object within the virtual environment, etc.). For example, if the instance of the product is a car, the user may drive the digital object rendered as a virtual car. If the instance of the product is a purse, the user may carry the digital object rendered as a virtual purse. In some embodiments, the user may also present other content that is stored on the blockchain in association with the token, such as the content added by the entities associated with the supply chain, the manufacturers, third-party entities, and previous/current owners of the token. The user may present the content within the virtual environment (e.g., in the game) or in a chat room associated with the game.

In some embodiments, the reward system may establish communication with multiple virtual environment platforms such that the user may transport the digital object from one virtual environment to another virtual environment seamlessly.

In one or more embodiments, when the user is authenticated and verified as the owner of the token, the user can request that a second, temporary token (also referred to as a “child token”) be generated based on the first token (also referred to as a “parent token”). The second token may be generated based on the first token (e.g., a hash value of the first token, performing a mathematical calculation based on the first token, etc.), such that the reward system may determine the relationship between the first token and the second token. In some embodiments, the reward system may store the second token in a data storage in association with the first token. The second token can be provided to another user who can use the second token to access digital content (e.g., a digital rendering of the instance of the product that is viewable in the virtual computing environment) for a limited duration (e.g., before the second token expires). For example, with the second token the other user can manipulate the digital rendering of the product to determine whether or not he or she wants to purchase the product. In some embodiments, the second token is transmitted to the device of the other user. For example, based on the interaction between the first user and the instance of the product, the reward system may retrieve the token associated with the instance of the product (e.g., the “parent token”) and may generate a child token based on the parent token. The reward system may determine an expiration time for the child token (which may be configured automatically based on a default duration or determined by the owner of the parent token). The reward system may transmit the child token to the device of the first user, such that the first user can access the digital object associated with the product within a virtual environment based on the child token.

In other embodiments, other players in the game may also initiate the process as the avatars (e.g., virtual representations of the players) are in proximity (e.g., within a threshold distance) with the digital object in the game. For example, a player who is in proximity from the digital object may “scan the code” of the digital object by performing a predetermined action and/or motion in the game (e.g., waving at the digital object, jumping in front of the digital object, etc.). Once the player performs the predetermined action and/or motion with respect to the digital object, a request to access the digital content can be sent and the second token can be generated. If the second token has not yet expired, access to the digital content can be granted to the player.

In some embodiments, instead of requiring the interaction between the device of the first user and the instance of the product, the reward system may provide the same functionalities as discussed herein (e.g., providing rewards and/or incentives, content sharing, generation and sharing of a child token, etc.) based on an activation of a code by the first device. For example, upon receiving a request from the second user, the reward system may generate the code (e.g., based on the token of the instance of the product, such as hashing the product). The code generated by the reward system may be the same as the code that appears on or affixed to the instance of the product. The reward system may transmit the code to the device of the first user based on the request (e.g., via SMS, e-mail, etc.). The first user may activate the code by inputting the code to the application on the device. In some embodiments, the code may be transmitted to the device of the first user in the form of a link (e.g., a web link, etc.), and the first user may activate the code by selecting the link. For example, based on the activation of the code on the device of the first user, the reward system may facilitate of a transfer of content associated with the instance of the product from the device of the second user to the device of the first user.

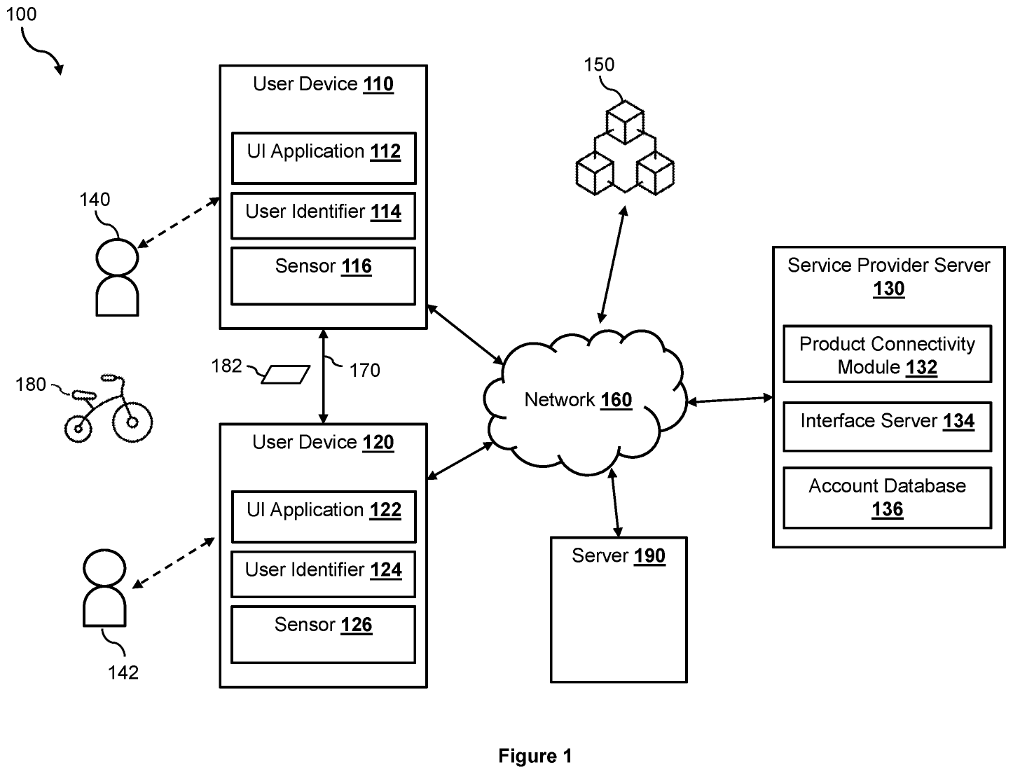

FIG. 1 illustrates a networked system 100, within which the reward system may be implemented according to one embodiment of the disclosure. Note that the present techniques may be applied in many different computing and technological environments, however, and are not limited to those shown in the figures. The networked system 100 includes a service provider server 130, a first user device 110, a second user device 120, a product blockchain 150, and a server 190 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The first user device 110 and second user device 120, in one embodiment, may be utilized by a first user 140 and a second user 142, respectively, to interact with the service provider server 130 over the network 160. For example, the first user 140 may use the first user device 110 to scan a code on an instance of a product 180 via a website hosted by, or a mobile application associated with, the service provider server 130. The first user device 110 and the second user device 120, in various embodiments, may be implemented using any appropriate combination of hardware and/or software configured for wired and/or wireless communication over the network 160. In various implementations, the first user device 110 and the second user device 120 may include at least one of a wireless cellular phone, wearable computing device, PC, laptop, etc.

The first user device 110 and the second user device 120, in one embodiment, include a user interface (UI) application 112 or a UI application 122 (e.g., a web browser, a mobile application, etc.), which may be utilized by the first user 140 and the second user 142 to interact with the service provider server 130 over the network 160. In one implementation, the UI application 112 and the UI application 122 each includes a software program (e.g., a mobile application) that provides a graphical user interface (GUI) for the first user 140 and the second user 142 to interface and communicate with the service provider server 130 via the network 160. In another implementation, the UI application 112 and the UI application 122 each include a browser module that provides a network interface to browse information available over the network 160. For example, the UI application 112 and the UI application 122 may be implemented, in part, as a web browser to view information available over the network 160.

The first user device 110 and the second user device 120, in various embodiments, may also include a sensor 116 or a sensor 126 configured to determine, track, monitor, and/or provide information regarding interactions between the first user device 110 and the second user device 120. In some embodiments, the sensor 116 and the sensor 126 include one or more of a camera, a RFID reader, a NFC reader, a microphone, a location sensor (e.g., GPS), and any other kind of sensor that may be used to facilitate interactions between the first user 140 and the second user 142.

The first user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user 140 with a particular user account (e.g., and a particular profile) maintained by the service provider server 130. Similarly, the second user device 120 may also include at least one identifier 124, which is similar in form and function to identifier 114 described above.

In various implementations, the first user 140 and the second user 142 are able to input data and information into an input component (e.g., a keyboard) of the first user device 110 or the second user device 120. For example, the first user 140 may use the input component to interact with the UI application 112 (e.g., to submit a code associated with a product, to retrieve content from third-party servers such as the service provider server 130, etc.).

The server 190, in one embodiment, may be maintained by a manufacturer of a product or any entity that wants to add content to the product blockchain 150. For example, the content added by the manufacturer may include information associated with the product (e.g., a serial number of the product, dimensions, colors, visual characteristics, edge-based attributes for object recognition, instruction manual, etc.), information associated with the manufacturer (e.g., a mission statement, etc.), advertisement content (e.g., text and/or multi-media content related to recommended products, etc.) and other information. It has been contemplated that the content generated and stored in association with the token by the manufacturer and/or other entities may include text data, multi-media data (e.g., audio data, video data, etc.) and augmented reality data. Thus, the content can be incorporated within an image or video of the corresponding instance of the product. Since each instance of the product may be made from different materials (e.g., materials from a different source or origin, etc.) or made using a different process, the individualized tokens and their associated transaction blocks (or metadata) may include information that is specific to that instance of the product.

The service provider server 130, in one embodiment, may be maintained by an online service provider, which may provide reward and user experience enhancement services for the first user 140 of the first user device 110 and the second user 142 of the second user device 120. The service provider server 130 may also include an interface server 134 that is configured to serve content (e.g., web content, product content, augmented reality content, etc.) to users and interact with users. For example, the interface server 134 may include a web server configured to serve web content in response to HTTP requests. In another example, the interface server 134 may include an application server configured to interact with a corresponding application (e.g., a product connectivity mobile application) installed on the first user device 110 and/or the second user device 120 via one or more protocols (e.g., RESTAPI, SOAP, etc.). As such, the interface server 134 may include pre-generated electronic content ready to be served to users. Furthermore, the interface server 134 may also communicate with the UI application 112 and the UI application 122 and provide, via the UI application 112 and the UI application 122, a user interface that presents or displays digital content.

The service provider server 130, in one embodiment, may be configured to maintain one or more user accounts in an account database 136, each of which may be associated with a profile and may include account information associated with one or more individual users (e.g., the first user 140 associated with first user device 110 and the second user 142 associated with the second user device 120). For example, account information may include private information of users, such as one or more account numbers, passwords, digital wallets information, transaction history, Internet Protocol (IP) addresses, device information associated with the user account.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login or a request, and the user attributes may be utilized by the service provider server 130 to associate the user with one or more particular user accounts maintained by the service provider server 130.

In various embodiments, the service provider server 130 includes a product connectivity module 132 that implements the reward system as discussed herein. In some embodiments, the product connectivity module 132 may detect an interaction between the first user device 110 of the first user 140 and an instance of a product 180 (e.g., a Peloton® bike) associated with the second user 142 (e.g., a digital wallet of the second user 142 includes a token associated with the instance of the product 180). For example, first user 140 may use first user device 140 to scan a code (e.g., obtaining an image of the bar code or QR code using a camera, reading the code using an RFID reader and/or an NFC reader, etc.) of the instance of the product 180. The first user device 110 may submit the code via UI application 112 to UI application 122 on second user device 122. UI application 122 may determine a corresponding token based on the code, and cause a wireless connection 170 to be established between the first user device 110 and the second user device 120 to allow sharing of content 182 between the two devices.

In one embodiment, once the wireless connection 170 is established, UI application 122 may access user-generated content stored on the second user device 120 and associated with the instance of the product 180. UI application 122 may then cause the user-generated content stored on the second user device 120 to be transmitted from the second user device 120 to the first user device 110 via the wireless connection 170 and presented on the UI application 112. In this way, user-generated content from the second user device 120 can be shared and viewed on the first user device 110, without a third party server.

In certain embodiments, UI application 112 and/or UI application 122 determine one or more attributes associated with the wireless connection 170, such as the duration of the wireless connection 170 or a detected distance between the first user device 110 and the second user device 120. In one example, location information may be directly entered into the first user device 110 by the first user 140 and into the second user device 120 by the second user 142 via a user input component, such as a keyboard, touch display, and/or voice recognition microphone to determine the distance.

Product connectivity module 132, in various embodiments, evaluates or analyzes the one or more attributes of the wireless connection 170, along with the content 182 shared between first user device 110 and second user device 120. In the event it is determined that the first user 140 purchased a second instance of the product (i.e., another Peloton® bike), product connectivity module 132 may transmit a reward to the second user 142 based on the one or more attributes. For example, the longer the duration of the connection 170 and the more content 182 shared, the better the reward earned by the second user 142. For example, the reward may include a discount on a future purchase, a free product, and/or points to use on a future purchase.

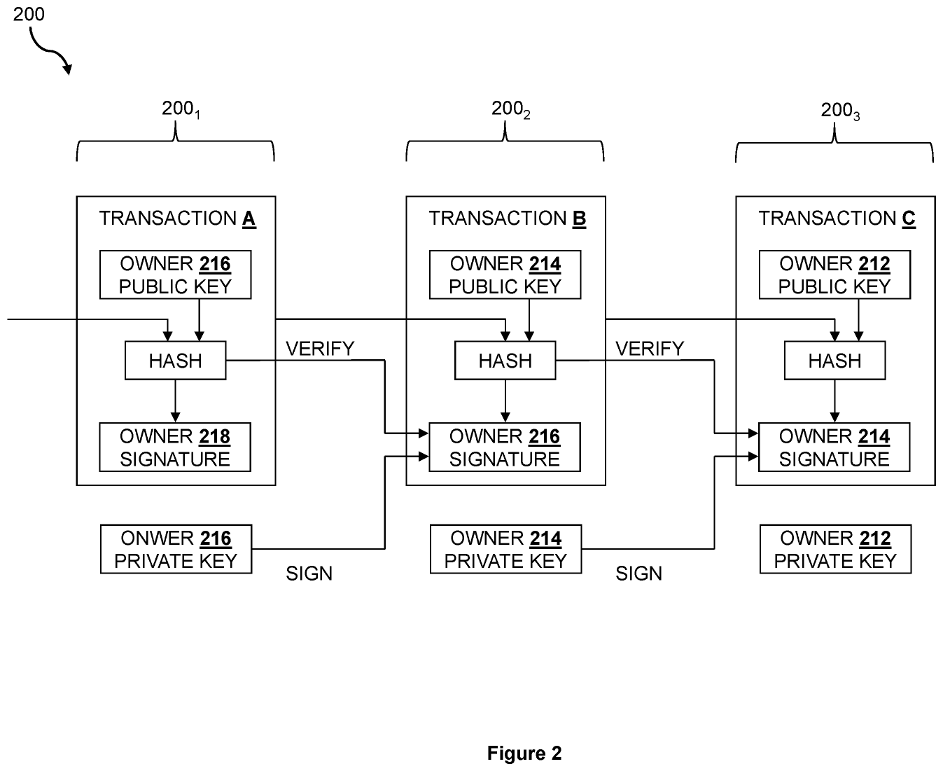

FIG. 2 illustrates an example electronic token 200 according to one embodiment of the disclosure. The electronic token (or simply a “token”) 200 may correspond to an instance of the product (e.g., instance of a product 180). The electronic token 200 is an electronic product that is transferrable among different parties based on a particular protocol. In some embodiments, the electronic token 200 may be defined as a chain of digital signatures provided by previous owners of the electronic token 200 to subsequent owners of the electronic token. In the illustrated embodiment, the electronic token 200 is owned by an owner 212, and FIG. 2 illustrates how the electronic token 200 is defined by the digital signatures of the previous owners 214, 216, and 218. Specifically, in transaction A, a hash of the public key of owner 216 (i.e., the owner receiving, as a result of transaction A, the electronic token 200₁ defined by digital signatures provided up to transaction A) and the previous transaction (not illustrated, but occurring prior to transaction A) was signed by owner 218 (i.e., the owner providing, as a result of transaction A, the electronic token 200₁ defined by digital signatures provided up to transaction A) using a private key and added to an initial electronic token (which was defined by digital signatures provided up to the transaction prior to transaction A) such that the electronic token 200₁ was transferred to owner 216.

Similarly, in transaction B, a hash of the public key of owner 214 (i.e., the owner receiving, as a result of transaction B, an electronic token 200₂ defined by digital signatures provided up to transaction B) and transaction A was signed by owner 216 using a private key and added to the electronic token 200₂such that the electronic token 200₂ was transferred to owner 214. Similarly, in transaction C, a hash of the public key of owner 212 (i.e., the owner receiving, as a result of transaction C, the electronic token 200₃ defined by digital signatures provided up to transaction C) and the transaction B was signed by owner 214 using a private key and added to the electronic coin 200₃ such that the electronic token 300 was transferred to owner 212. As is understood in the art, any payee receiving an electronic token (e.g., owner 216 in transaction A, owner 214 in transaction B, and owner 212 in transaction C) can verify the signatures to verify the chain of ownership of the electronic token 200.

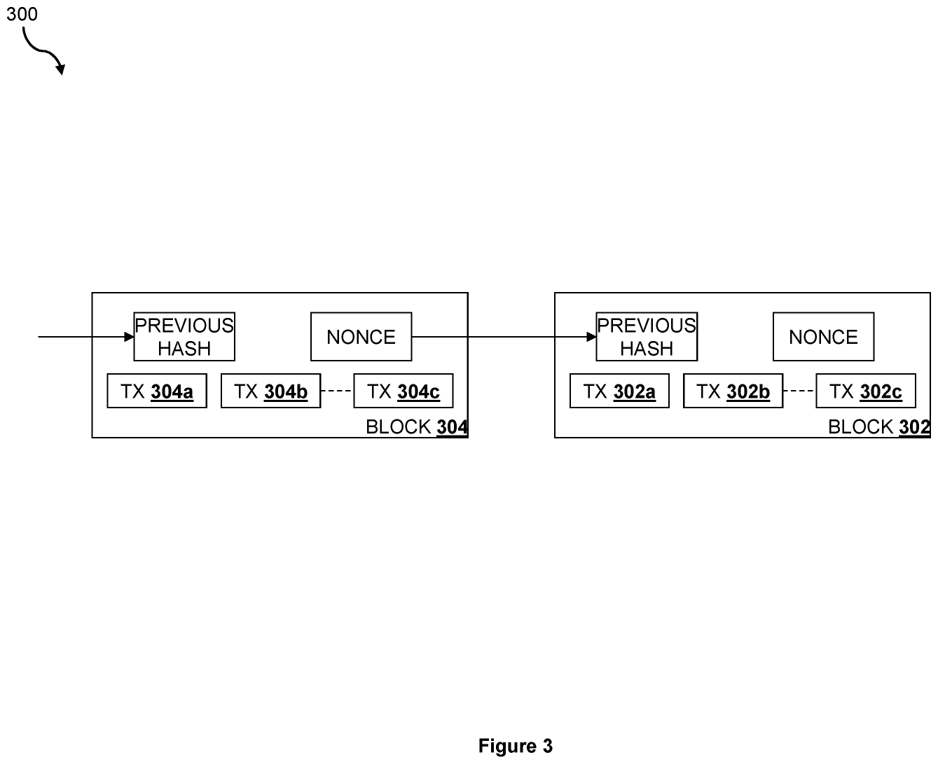

In some embodiments, tokens are transferred to a wallet associated with the product connectivity module 132. The transfer of the tokens to the wallet may be recorded as new transaction blocks in product blockchain 150. FIG. 3 illustrates an example ledger 300 according to one embodiment of the disclosure. The ledger 300 operates to verify previous transactions (e.g., transfer) and ownership of electronic tokens (e.g., referring back to FIG. 2, owner 216 in transaction A, owner 214 in transaction B, and owner 212 in transaction C) such that owners did not “double-spend” (e.g., use a private key to sign any previous transactions involving) that electronic token. To produce the ledger 300, a single device (e.g., the service provider server 130) or a distributed network of devices may operate to agree on a single history of transactions in the order in which they were received such that it may be determined that a transaction between a transferrer and a transferee of a token is the first transaction associated with that electronic token from the transferrer. Each device in the distributed network operates to collect new transactions into a block, and then to increment a proof-of work system that includes determining a value that when hashed with the block provides a required number of zero bits.

For example, for a block 302 that includes a plurality of transactions 302a, 302b, and up to 302c, a device in the distributed network may increment a nonce in the block 302 until a value is found that gives a hash of the block 302 the required number of zero bits. The device may then “chain” the block 302 to the previous block 304 (which may have been “chained” to a previous block, not illustrated, in the same manner). When devices in the distributed network find the proof-of-work for a block, that block (e.g., block 302) is broadcast to the distributed network, and other devices in the distributed network will accept that block if all the transactions in it are valid and not already transferred (which may be determined by creating the next block using the hash of the accepted block 302). The distributed network will always consider the longest chain of blocks to be the correct one and will operate to continue to extend it. In a Proof of Stake (PoS) system, a validator that correctly proposed the next block and the proposal is attested by a majority of validators, then the next block would be accepted as the correct one. If a device receives two different versions of a block, it will work on the first block received, but save the second block received in case the branch of the chain that includes the second block becomes longer (at which point that device with switch to working on the branch of the chain that includes the second block).

As discussed herein, codes that correspond to the tokens may be provided with the instances of the product (e.g., printed, engraved, attached an RFID tag and/or NFC chip to the product, etc.). A request (instances of the product) may be initiated via the UI application 112 (e.g., the Berify™ mobile application) by obtaining the code that is provided with the instance of the product (e.g., scanning the code, swiping the NFC chip, reading the RFID tag, etc.). In one example, the first user 140 is in close proximity of the instance of the product 180 owned/worn by the second user 142. The instance of the product 180 in FIG. 1 is a Peloton® bicycle. As shown, the first user 140 may use the first user device 110 to obtain a code provided with that instance of the product 180. The first user device 110 may include a camera for capturing an image of a bar code or a QR code. The first user device 110 may also include an RFID reader for reading an RFID tag, and/or include an NFC reader for reading an NFC chip. Upon scanning the code, the UI application 112 of the first user device 110 may transmit the request (which may include the code) to the service provider server 130 or to UI application 122 on the second user device 120.

Upon receiving the request and the code, the product connectivity module 132 may retrieve (or otherwise obtain) additional information from the first user device 110 via application programming interface (API) calls. For example, the product connectivity module 132 may obtain device attributes of the first user device 110 such as a geographical location of the first user device 110 determined by the sensor 116, a network address of the first user device 110, a device identifier of the first user device 110, a wallet account number of a wallet associated with the first user 140, a device screen size, a default language, a color depth of a display, and other device specific data. In some embodiments, the product connectivity module 132 may also prompt the first user 140 to capture an image of the instance of the product 180.

As discussed herein, the content that has been added to the blockchain may include data added by an owner of the instance of the product 180 (e.g., the second user 142). The content may also include user-generated content provided by previous and/or current owners of the instance of the product 180. As discussed herein, a current owner may access a user interface provided by the product connectivity module 132 and may upload user-generated content via the user interface. The user-generated content may include data associated with the ownership of the instance of the product (e.g., enhancement, modifications done to the instance of the product by the owner, videos/audios recording ownership experience of the instance of the product, etc.). As such, an owner of the product (and/or a person scanning the code corresponding to the instance of the product) may access the user-generated content from previous and current owners via the product connectivity application 132. In some embodiments, the type of content provided to the first user device 110 may depend on whether the first user device 110 is associated with a digital wallet that has possession of the token corresponding to the instance of the product. As such, the current owner of the instance of the product 180 may access certain content (e.g., certain user-generated content from previous owners, certain proprietary data from the manufacturer, etc.) that is inaccessible by a non-owner. Thus, the product connectivity module 132 may select portions of the content from the blockchain in association with the instance of the product 180 based on whether the requesting device has possession of the token.

In some embodiments, the content may include promotional data for promoting the product or other related products from the manufacturer (e.g., discount offers, advertisements, etc.). Thus, through the product connectivity module 132 and the product connectivity applications, the manufacturers can directly communicate with their consumers and others who may be interested in their products (e.g., the people who scan the codes associated with different instances of the product). The manufacturer may upload different promotional data to the blockchain at different times to provide new promotional content to the owners and other potential consumers of the product. In some embodiments, the product connectivity module 132 may enable the manufacturer to provide targeted promotional data.

For example, the product connectivity module 132 may allow the manufacturer to provide different versions of promotional materials (e.g., for different products, for different discounts, for different incentives, etc.), and configurations for when the different versions of the promotional materials can be presented to user devices. The configurations may be location-specific (e.g., show a particular promotional material when the requesting device is located within a certain geographical area, etc.), time-specific (e.g., show a particular promotional material when the request is made at a specific time, etc.), demographic-specific (e.g., show a particular promotional material when the requester is within a certain age-range, is a particular gender, has a certain income range, etc.) or dependent on any attribute of the requester and/or the requesting device. The configurations and the different versions of the promotional materials may be stored in the blockchain (or in a data storage linked to the blockchain) and may be retrieved by an application (e.g., UI application 112 or UI application 122) of a user device as the application scans a code corresponding to an instance of the product. Based on the configurations and attributes of the user device, the application may select and present one or more of the promotional materials. For example, the application may determine a location of the first user device 110 that scans the code, a time of day when the code is scanned, attributes of a user of the user device (e.g., an age, a gender, an income, etc.), and/or other attributes, and may select the appropriate promotional materials based on the attributes. This way, the manufacturers can provide targeted advertisement to the public through the product connectivity platform.

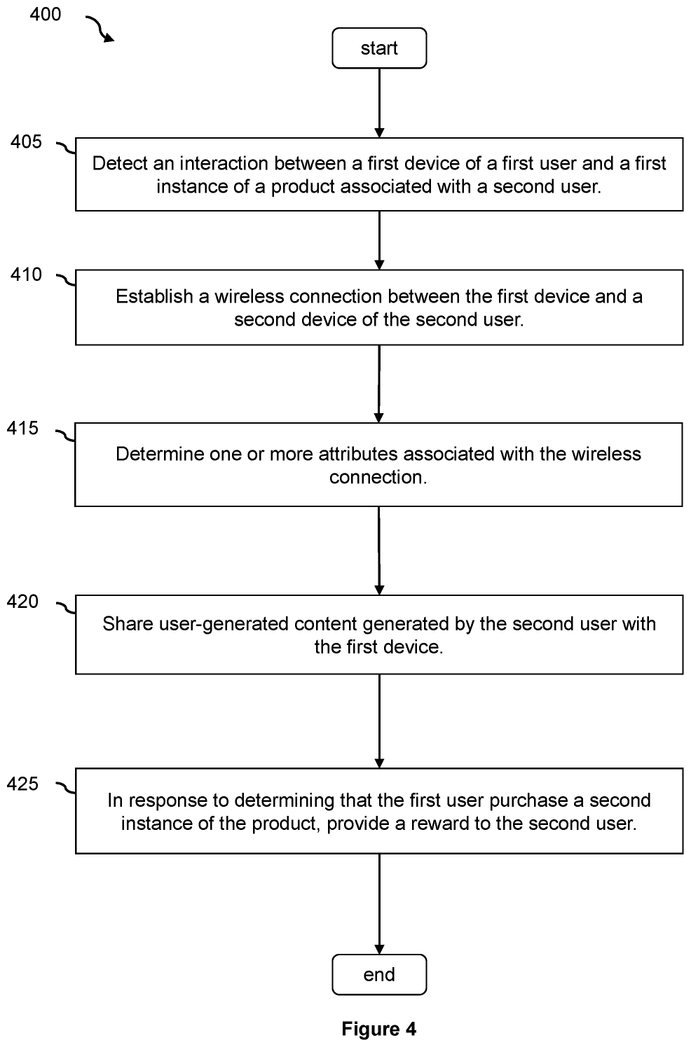

FIG. 4 illustrates a process 400 for providing a reward to the second user 142 according to various embodiments of the disclosure. In some embodiments, at least a portion of the process 400 may be performed by the product connectivity module 132, UI application 112, or UI application 122. The process 400 may begin by detecting (at step 405) an interaction between a first user device 110 of a first user 140 and a first instance of a product 180 associated with a second user 142. For example, the first user device 110 may capture a code on the first instance of the product 180, where the first instance of the product is owned by the second user 142, as evidenced by the appropriate token in the wallet of the second user 142. In various embodiments, product connectivity module 132 can traverse a product blockchain 150 associated with the instance of the product 180 and determines an identity of the second user 142 corresponding to the code based on the traversing. The process 400 then establishes (at step 410) a wireless connection 170 between the first user device 110 and the second user device 120 of the second user 142. For example, the presence of UI application 112 on first user device 110 and UI application 122 on second user device 120 may cause a wireless connection 170 to be established between the two user devices.

The process 400 determines (at step 415) one or more attributes associated with the wireless connection 170. For example, product connectivity module 132 or UI application 112 and UI application 122 determine a duration of the wireless connection 170 or a detected distance between the user devices. The second user 142 can be rewarded based on these attributes. The process 400 then shares (at step 420) user-generated content 182 associated with the instance of the product 180 with the first user device 110. In some embodiments, the user-generated content 182 is content generated by the second user 142, such as reviews, videos, pictures, etc. The process subsequently (at step 425) determines that the first user 140 has purchased a second instance of the product, and in response to this determination, provides a reward to the second user 142. For example, product connectivity module 132 may determine that the first user 140 has purchased a second instance of the product based on a record on a product blockchain associated with the second instance of the product.

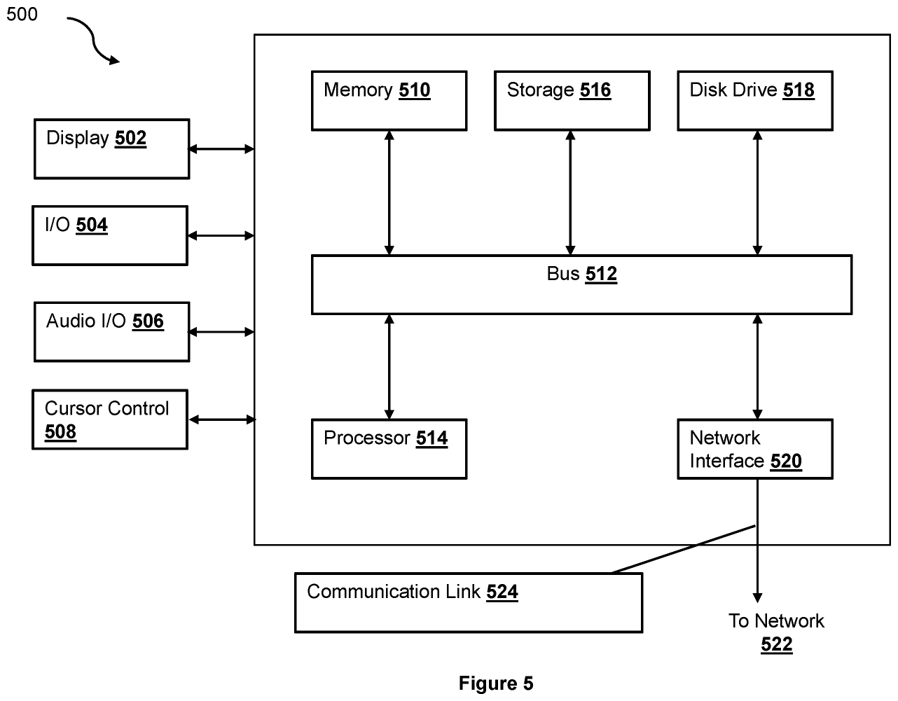

FIG. 5 is a block diagram of a computer system 500 suitable for implementing one or more embodiments of the present disclosure, including the service provider server 130, the server 190, first user device 110, and second user device 120. In various implementations, the first user device 110 and the second user device 120 may each include a mobile cellular phone, personal computer (PC), laptop, wearable computing device, etc. adapted for wireless communication, and each of the service provider server 130 and the server 190 may include a network computing device, such as a server. Thus, it should be appreciated that the devices/servers 110, 120, 130, and 190 may be implemented as the computer system 500 in a manner as follows.

The computer system 500 includes a bus 512 or other communication mechanism for communicating information data, signals, and information between various components of the computer system 500. The components include an input/output (I/O) component 504 that processes a user (i.e., sender, recipient, service provider) action, such as selecting keys from a keypad/keyboard, selecting one or more buttons or links, etc., and sends a corresponding signal to the bus 512. The I/O component 504 may also include an output component, such as a display 502 and a cursor control 508 (such as a keyboard, keypad, mouse, etc.). The display 502 may be configured to present a login page for logging into a user account. An optional audio input/output component 506 may also be included to allow a user to use voice for inputting information by converting audio signals. The audio I/O component 506 may allow the user to hear audio. A transceiver or network interface 520 transmits and receives signals between the computer system 500 and other devices, such as another user device or a service provider server via a network 522, such as network 160 of FIG. 1. In one embodiment, the transmission is wireless, although other transmission mediums and methods may also be suitable. A processor 514, which can be a micro-controller, digital signal processor (DSP), or other processing component, processes these various signals, such as for display on the computer system 500 or transmission to other devices via a communication link 524. The processor 514 may also control transmission of information, such as cookies or IP addresses, to other devices.

The components of the computer system 500 also include a system memory component 510 (e.g., RAM), a static storage component 516 (e.g., ROM), and/or a disk drive 518 (e.g., a solid-state drive, a hard drive). The computer system 500 performs specific operations by the processor 514 and other components by executing one or more sequences of instructions contained in the system memory component 510. For example, the processor 514 can perform the token issuance and item authentication functionalities described herein according to the process 400.

Logic may be encoded in a computer readable medium, which may refer to any medium that participates in providing instructions to the processor 514 for execution. Such a medium may take many forms, including but not limited to, non-volatile media, volatile media, and transmission media. In various implementations, non-volatile media includes optical or magnetic disks, volatile media includes dynamic memory, such as the system memory component 510, and transmission media includes coaxial cables, copper wire, and fiber optics, including wires that comprise the bus 512. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 500. In various other embodiments of the present disclosure, a plurality of computer systems 500 coupled by the communication link 524 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
one or more hardware processors; and
a non-transitory memory storing instructions, that when executed by the one or more hardware processors, cause the one or more hardware processors to perform operations comprising:
detecting an interaction between a first device of a first user and a first instance of a product, wherein the interaction comprises the first device capturing a code corresponding to the first instance of the product;
identifying a token corresponding to a second user different from the first user based on the interaction, wherein the token indicates the second user as an owner of the first instance of the product;
in response to the identifying the token corresponding to the second user, establishing a first wireless connection between the first device and a second device of the second user, wherein the second device is different from the first instance of the product;
transmitting first user-generated content stored on the second device and associated with the first instance of the product to the first device via the first wireless connection;
transmitting second user-generated content stored on a third-party server and associated with the token to the first device via a second wireless connection different from the first wireless connection;
connecting a first user account associated with the first user with a second user account associated with the second user in a decentralized network associated with the product based on the interaction;
determining that the first user account is connected to a third user account of a third user via the second user account on the decentralized network;
in response to detecting that the first device is within a distance threshold from a third device of the third user, establishing a third wireless connection between the first device and the third device based on the first user account being connected to the third user account on the decentralized network; and
causing third user-generated content associated with a second instance of the product owned by the third user to be transmitted from the third device to the first device via the third wireless connection.

2. The system of claim 1, wherein the operations further comprise:
identifying, from a plurality of tokens stored on a blockchain, the token corresponding to the first instance of the product based on the code;
accessing data associated with the first instance of the product based on traversing the blockchain using the token; and
transmitting the data to the first device.

3. The system of claim 1, wherein the operations further comprise:
determining one or more attributes associated with the first wireless connection between the first device and the second device;
generating rewards data for the second user based on the one or more attributes; and
recording the rewards data on the blockchain in association with the token.

4. The system of claim 3, wherein the one or more attributes comprises a duration of the first wireless connection.

5. The system of claim 3, wherein the one or more attributes comprises an amount of data transmitted via the first wireless connection.

6. The system of claim 5, wherein the rewards data is generated in proportion to the amount of data transmitted via the first wireless connection.

7. The system of claim 1, wherein the operations further comprise:
accessing a plurality of user-generated contents stored on the third-party server and associated with the token; and
restricting the first device from accessing a portion of the plurality of user-generated contents based on a first relationship between the first user and the first instance of the product, wherein the plurality of user-generated contents is accessible by the second device based on a second relationship between the second user and the first instance of the product.

8. The system of claim 1, wherein the operations further comprise:
causing the second user-generated content to be presented on the first device.

9. The system of claim 1, wherein the token is a first token, and wherein the operations further comprise:
generating, based on the first token, a second token as a child token of the first token, wherein the second token is associated with a set of restrictions;
establishing a relationship between the first token and the second token in a data storage; and
transmitting the second token to the first device, the second token enabling the first user of the first device to access a digital version of the product in a virtual computer environment based on the relationship between the first token and the second token.

10. The system of claim 9, wherein the operations further comprise:
receiving, from a computing device associated with the virtual computing environment, a request to access the digital version of the product based on the second token;
determining the relationship between the second token and the first token; and
providing the computing device access to the digital version of the product based on the relationship and the set of restrictions.

11. A method comprising:
detecting, by a computer system, an interaction between a first device of a first user and a first instance of a product, wherein the interaction comprises the first device capturing a code corresponding to the first instance of the product;
identifying, by the computer system a non-fungible token (NFT) corresponding to a second user different from the first user based on the interaction, wherein the NFT indicates the second user as an owner of the first instance of the product based on one or more records on a blockchain;
in response to the identifying the NFT corresponding to the second user, establishing a first wireless connection between the first device and a second device of the second user;
transmitting first user-generated content stored on the second device and associated with the first instance of the product to the first device via the first wireless connection;
transmitting, by the computer system, second user-generated content stored on a third-party server and associated with the NFT to the first device via a second wireless connection different from the first wireless connection;
connecting, by the computer system, a first user account associated with the first user with a second user account associated with the second user in a decentralized network associated with the product based on the interaction;
determining, by the computer system, that the first user account is connected to a third user account of a third user via the second user account on the decentralized network;
detecting that the first device is within a distance threshold from a third device of the third user;
in response to detecting that the first device is within the distance threshold from the third device, establishing a third wireless connection between the first device and the third device; and
causing third user-generated content associated with a second instance of the product owned by the third user to be transmitted from the third device to the first device via the third wireless connection based on the first user account being connected to the third user account on the decentralized network.

12. The method of claim 11, further comprising:
identifying, from a plurality of NFTs stored on a blockchain, the NFT corresponding to the first instance of the product based on the code;
accessing data associated with the first instance of the product based on traversing the blockchain using the NFT; and
transmitting the data to the first device.

13. The method of claim 11, further comprising:
determining one or more attributes associated with the first wireless connection between the first device and the second device;
generating rewards data for the second user based on the one or more attributes; and
recording the rewards data on the blockchain in association with the NFT.

14. The method of claim 13, wherein the one or more attributes comprises a frequency of data transmission via the first wireless connection.

15. The method of claim 13, wherein the one or more attributes comprises an amount of data transmitted via the first wireless connection.

16. The method of claim 13, wherein the rewards data is generated in proportion to the one or more attributes associated with the first wireless connection.

17. The method of claim 11, further comprising:
accessing a plurality of user-generated contents stored on the third-party server and associated with the NFT; and
restricting the first device from accessing a portion of the plurality of user-generated contents based on a first relationship between the first user and the first instance of the product, wherein the plurality of user-generated contents is accessible by the second device based on a second relationship between the second user and the first instance of the product.

18. The method of claim 11, wherein the second user-generated content comprises augmented reality data, and wherein the method further comprises:
incorporating the augmented reality data within an image captured by the first device.

19. The method of claim 11, wherein the NFT is a first token, and wherein the method further comprises:
generating, based on the first token, a second token as a child token of the first token, wherein the second token is associated with a set of restrictions;
establishing a relationship between the first token and the second token in a data storage; and
transmitting the second token to the first device, the second token enabling the first user of the first device to access a digital version of the product in a virtual computer environment based on the relationship between the first token and the second token.

20. The method of claim 19, further comprising:
receiving, from a computing device associated with the virtual computing environment, a request to access the digital version of the product based on the second token;
determining the relationship between the second token and the first token; and
providing the computing device access to the digital version of the product based on the relationship and the set of restrictions.
